(19) United States
(12) Patent Application Publication
(10) Pub. No.: US 2025/0307067 A1
(43) Pub. Date: Oct. 2, 2025

(54) METHOD, APPARATUS, AND COMPUTER PROGRAM FOR RESPONDING TO SYSTEM INCIDENTS BASED ON GENERATIVE ARTIFICIAL INTELLIGENCE

(71) Applicant: SAMSUNG SDS CO., LTD., Seoul (KR)

(72) Inventor: Jaehyuk CHO, Seoul (KR)

(73) Assignee: SAMSUNG SDS CO., LTD., Seoul (KR)

(21) Appl. No.: 19/095,507

(22) Filed: Mar. 31, 2025

(30) Foreign Application Priority Data
Apr. 2, 2024 (KR) 10-2024-0044646
May 30, 2024 (KR) 10-2024-0071111

(51) Int. Cl. G06F 11/07

(52) U.S. Cl. CPC G06F 11/0793; G06F 11/0736; G06F 11/079

(57) ABSTRACT

A processor implemented method including monitoring an event in a system, analyzing a log of the event to determine whether the event is a system incident, searching, responsive to the event being determined to be a system incident event, an internal knowledge base for causes of the system incident event and remedial actions for the system incident event, based on retrieval-augmented generation, prompting a first inquiry, the first inquiry including the log and a search result from the searching to a first LLM, and generating a first response including remedial actions for the system incident event by the first LLM, based on the first inquiry and the search result.

### CROSS-REFERENCE TO RELATED APPLICATION(S)

This application claims the benefit under 35 USC § 119(a) of 35 U.S.C. 119 to Korean Patent Application No. 10-2024-0044646, filed on Apr. 2, 2024, and Korean Patent Application No. 10-2024-0071111, filed on May 30, 2024, in the Korean Intellectual Property Office, the entire disclosures of which are incorporated herein by reference for all purposes.

### BACKGROUND

### 1. Field of the invention

The disclosure relates to an incident response method, apparatus, and computer program that identify causes of incidents occurring in a system when operating an IT service such as a cloud service, based on generative artificial intelligence (AI) with supplemented retrieval-augmented generation (RAG), and derive remedial actions.

### 2. Description of the Related Art

Recently, various IT services based on wired and wireless communication have been spreading, and accordingly, the types and sizes of equipment constituting IT service operating systems used to provide the service have been rapidly increasing, and furthermore, the manpower and costs required to operate and manage the system have been continuously increasing. In this regard, in the past, in order to reduce the manpower and costs required for operating and managing the system, actions were taken to reduce less important tasks, but these are only stopgap measures and are gradually revealing their limitations.

In the past, if operators of IT service operating systems wished to obtain operating information about the system or perform management, the work was often guided simply according to predetermined work information based on rules, and furthermore, since equipment from multiple vendors may be mixed in the system, it was more difficult to provide accurate information or perform management in response to equipment from various vendors.

In addition, when an incident occurs in the system, in order to resolve the incident, the system operator accesses the system and analyzes the logs to derive the causes of the incident and remedial actions. However, the time required to derive remedial actions described above may increase operational costs and adversely affect the reliability of the service provider.

To solve this problem, various artificial intelligence services based on large language model (LLM) have been recently used, and methods to reduce user intervention through the introduction of chatbots or application programming interfaces (APIs) are being applied. Nevertheless, it is still difficult for system operators to analyze system logs or metrics and shorten the time for search to derive remedial actions for incidents.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here provided a processor-implemented method including monitoring an event in a system, analyzing a log of the event to determine whether the event is a system incident, searching, responsive to the event being determined to be a system incident event, an internal knowledge base for causes of the system incident event and remedial actions for the system incident event, based on retrieval-augmented generation, prompting a first inquiry, the first inquiry including the log and a search result from the searching to a first LLM, and generating a first response including remedial actions for the system incident event by the first LLM, based on the first inquiry and the search result.

The method may include prompting, in a first case that the generated first response does not satisfy a predetermined reference, a second inquiry, the second inquiry including the log to a second LLM and generating a second response including remedial actions for the system incident event by the second LLM, based on the second inquiry.

The prompting the second inquiry to the second LLM may include determining whether the log includes private information, blocking the log from being prompted to the second LLM responsive to the log including the private information, obfuscating the private information of the log to generate an obfuscated log, and prompting the second inquiry including the obfuscated log to the second LLM.

The method may include collecting metrics of the system related to the system incident event between the analyzing the log and the prompting the first inquiry, the first LLM being configured to further generate status of the system related to the system incident event, based on the metrics.

Responsive to the first case that the generated first response not satisfying the predetermined reference, the method may include generating the second response according to the system incident event including one of a second case where accuracy of the first response evaluated by the first LLM is less than a predetermined score, a third case where there is no information related to the causes of the system incident event or the remedial actions in the internal knowledge base, and a fourth case where the system incident event is related to open source.

The method may include identifying whether a user of the system has an authority to execute a first remedial action included in the first response and a second remedial action included in the second response, providing the first response to the user responsive to the first response satisfying the predetermined reference, and providing the second response to the user responsive to the first response not satisfying the predetermined reference, and the second response may be generated by prompting the second inquiry including the obfuscated log to the second LLM.

The method may include providing a first remedial action included in the first response or a second remedial action included in the second response to a user of the system, prompting a third inquiry of the user for the first remedial action or the second remedial action to the first LLM, and generating a third remedial action corresponding to the third inquiry by the first LLM.

The method may include identifying a user's authority to execute the third remedial action and providing the third remedial action to the user.

The method may include providing a first remedial action included in the first response or a second remedial action included in the second response to a user of the system, obfuscating private information included in a fourth inquiry of the user for the first remedial action or the second remedial action, prompting the fourth inquiry to the second LLM, and generating a fourth remedial action corresponding to the fourth inquiry by the second LLM.

In a general aspect, here is provided an apparatus including a processor configured to execute instructions, a memory storing the instructions, and an execution of the instructions configures the processor to monitor an event in a system, analyze a log of the event to determine whether the event is a system incident, search, responsive to the event being determined to be a system incident event, an internal knowledge base for causes of the system incident event and remedial actions for the system incident event, based on retrieval-augmented generation, prompt a first inquiry, the first inquiry including the log and a search result from the searching to a first LLM, and generate a first response including remedial actions for the system incident event by the first LLM, based on the first inquiry and the search result.

The processor may be further configured to prompt, in a first case that the generated first response does not satisfy a predetermined reference, a second inquiry, the second inquiry including the log to a second LLM and generate a second response including remedial actions for the system incident event by the second LLM, based on the second inquiry.

The prompting of the second inquiry may include determining whether the log includes private information, blocking the log from being prompted to the second LLM responsive to the log including the private information, obfuscating the private information of the log to generate an obfuscated log, and prompting the second inquiry including the obfuscated log to the second LLM.

The processor may be further configured to collect metrics of the system related to the system incident event between the analyzing the log and the prompting the first inquiry and the first LLM may be configured to further generate status of the system related to the system incident event, based on the metrics.

Responsive to first case that the generated first response not satisfying the predetermined reference, the generating the second response further may include generating the second response according to the system incident event including one of a second case where accuracy of the first response evaluated by the first LLM is less than a predetermined score, a third case where there is no information related to the causes of the system incident event or the remedial actions in the internal knowledge base, and a fourth case where the system incident event is related to open source.

The processor may be further configured to identify whether a user of the system has an authority to execute a first remedial action included in the first response and a second remedial action included in the second response, provide the first response to the user responsive to the first response satisfying the predetermined reference, and provide the second response to the user responsive to the first response not satisfying the predetermined reference, and the second response may be generated by prompting the second inquiry including the obfuscated log to the second LLM.

The processor may be further configured to provide a first remedial action included in the first response or a second remedial action included in the second response to a user of the system, prompt a third inquiry of the user for the first remedial action or the second remedial action to the first LLM, and generate a third remedial action corresponding to the third inquiry by the first LLM.

The processor may be further configured to provide a first remedial action included in the first response or a second remedial action included in the second response to a user of the system, obfuscate private information included in a fourth inquiry of the user for the first remedial action or the second remedial action as an obfuscated fourth inquiry, prompt the obfuscated fourth inquiry to the second LLM, and generate a fourth remedial action corresponding to the obfuscated fourth inquiry by the second LLM.

The processor may be further configured to identify a user's authority to execute the third remedial action or the fourth remedial action and provide one of the third remedial action and the fourth remedial action to the user.

In a general aspect, here is provided a computer-readable storage medium storing instructions configured to, when executed by a processor, cause a computing apparatus including the processor to implement operations which include monitoring an event in a system, analyzing a log of the event to determine whether the event is a system incident, searching, responsive to the event being determined to be a system incident event, an internal knowledge base for causes of the system incident event and remedial actions, based on retrieval-augmented generation, prompting a first inquiry, the first inquiring including the log and a search result from the searching to a first LLM, and generating a first response including remedial actions for the system incident event by the first LLM, based on the first inquiry and the search result.

The operations may be further include prompting, in a first case that the generated first response does not satisfy a predetermined reference, a second inquiry, the second inquiry including the log, causes of the incident and remedial actions to a second LLM and generating a second response to the second inquiry by the second LLM, and the prompting the second inquiry to the second LLM may include determining whether the log included in the second inquiry includes private information, blocking the log from being prompted to the second LLM responsive to the log including private information, obfuscating the private information of the log to generate an obfuscated log, and prompting the second inquiry including the obfuscated log to the second LLM.

### BRIEF DESCRIPTION OF THE DRAWINGS

FIG. 1 is a block diagram schematically illustrating an incident response system according to an embodiment of the disclosure.

FIG. 2 is a flowchart illustrating an incident response method according to an embodiment of the disclosure.

FIG. 3 is a block diagram specifically illustrating an incident response system according to an embodiment of the disclosure.

FIG. 4 is a diagram illustrating a first prompt and a first response according to an embodiment of the disclosure.

FIG. 5 is a diagram illustrating evaluation of accuracy of a first response generated according to an embodiment of the disclosure.

FIG. 6 is a flowchart illustrating specific steps in which a second prompt is input to a second LLM according to an embodiment of the disclosure.

FIG. 7 is a diagram illustrating an obfuscated prompt and an obfuscated log according to an embodiment of the disclosure.

FIG. 8 is a flowchart illustrating specific steps in which a user executes remedial actions according to an embodiment of the disclosure.

FIG. 9 is a block diagram schematically illustrating the configuration of an incident response apparatus according to an embodiment of the disclosure.

Throughout the drawings and the detailed description, unless otherwise described or provided, the same, or like, drawing reference numerals may be understood to refer to the same, or like, elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when a component or element is described as being “on”, “connected to,” “coupled to,” or “joined to” another component, element, or layer it may be directly (e.g., in contact with the other component or element) “on”, “connected to,” “coupled to,” or “joined to” the other component, element, or layer or there may reasonably be one or more other components, elements, layers intervening therebetween. When a component or element is described as being “directly on”, “directly connected to,” “directly coupled to,” or “directly joined” to another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

As used in connection with various example embodiments of the disclosure, any use of the terms “module” or “unit” means hardware and/or processing hardware configured to implement software and/or firmware to configure such processing hardware to perform corresponding operations, and may interchangeably be used with other terms, for example, “logic,” “logic block,” “part,” or “circuitry”. As one non-limiting example, an application-predetermined integrated circuit (ASIC) may be referred to as an application-predetermined integrated module. As another non-limiting example, a field-programmable gate array (FPGA) or an application-specific integrated circuit (ASIC) may be respectively referred to as a field-programmable gate unit or an application-specific integrated unit. In a non-limiting example, such software may include components such as software components, object-oriented software components, class components, and may include processor task components, processes, functions, attributes, procedures, subroutines, segments of the software. Software may further include program code, drivers, firmware, microcode, circuits, data, database, data structures, tables, arrays, and variables. In another non-limiting example, such software may be executed by one or more central processing units (CPUs) of an electronic device or secure multimedia card.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

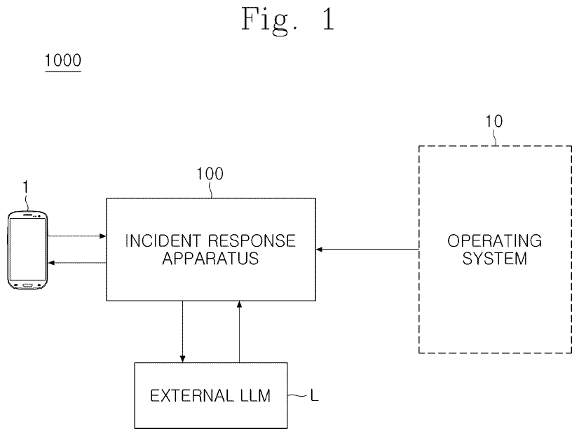

FIG. 1 is a block diagram schematically illustrating an incident response system according to an embodiment of the disclosure.

Referring to FIG. 1, an incident response system 1000 according to an embodiment of the disclosure may include a terminal device 1, an incident response apparatus 100, a second large language model (LLM) L, and an IT service operating system 10.

The IT service operating system (hereinafter, “operating system”) 10 is a system that operates IT services such as cloud services, and may be provided with multiple devices such as servers necessary to provide one or more online services, information processing devices such as databases, and other network devices.

The terminal device 1 may communicate with the incident response apparatus 100 using a wired or wireless communication network. A user may receive services provided by the incident response apparatus 100 using the terminal device 1. The services provided by the incident response apparatus 100 will be described later.

The terminal device 1 may have a communication module for transmitting and receiving information, a memory for storing programs and protocols, a processor for executing various programs to perform calculations and control, and the like. Here, the terminal device 1 may be a mobile terminal such as a smartphone or tablet PC, or a fixed terminal such as a desktop. For example, the terminal device 1 may include a mobile phone, a smartphone, a laptop computer, a digital broadcasting terminal, a personal digital assistant (PDA), a portable multimedia player (PMP), a slate PC, a tablet PC, an ultrabook, or a wearable device (e.g., a smartwatch, smart glasses, or a head-mounted display (HMD)).

The communication network connecting the terminal device 1 and the incident response apparatus 100 and the operating system 10 may include a wired network and a wireless network, and specifically, may include various networks such as a local area network (LAN), a metropolitan area network (MAN), and a wide area network (WAN). In addition, the communication network may include the known World Wide Web (WWW). However, the communication network according to the disclosure is not limited to the networks described above, and may include a known wireless data network, a known telephone network, and a known wired or wireless television network.

The incident response apparatus 100 may be a device that responds to an incident that occurs during the operation of an IT service such as a cloud service, based on a generative AI with supplemented retrieval-augmented generation (RAG). If an incident occurs in a system providing IT services, the incident response apparatus 100 may respond to the incident by generating the status of the system where the incident occurred, the causes of the incident, and remedial actions for resolving the incident. The incident response apparatus 100 may provide the situation where the incident occurred, the causes of the incident, and remedial actions for resolving the incident to the system operator or user.

Although the incident response apparatus 100 is illustrated as a separate device from the operating system 10 in FIG. 1, the incident response apparatus 100 may be a module or device inside the operating system 10, or may also be implemented in the form of software running on a server of the operating system 10. In addition, although the incident response apparatus 100 is illustrated to be directly connected to the terminal device 1, the incident response apparatus 100 may be connected to a server (not shown) of the operating system 10, thereby providing services such as remedial actions for resolving the incident to the terminal device 1 through the server, depending on the embodiment.

The incident response apparatus 100 may generate response messages to various enquiries input by the user through the terminal device 1 while being interlinked with the LLM. The incident response apparatus 100 according to the embodiment of the disclosure may be interlinked with a first LLM directly operated by a company or a specific organization and a second LLM L serviced by a third party externally. That is, the first LLM may be an internal LLM, and the second LLM L may be an external LLM. Here, the LLM may utilize Llamma, Mixtral, GPT-4,Gemini, openbuddy, Azure OpenAI, etc., but it is not limited thereto, and various models may be utilized in addition thereto. In this case, the first LLM may be Llamma or Mixtral, and the second LLM L may be GPT-4 or Gemini. The first LLM may be fine-tuned for use in the incident response apparatus 100, and depending on the embodiment, it is also possible to develop and utilize an LLM exclusively for the incident response apparatus 100.

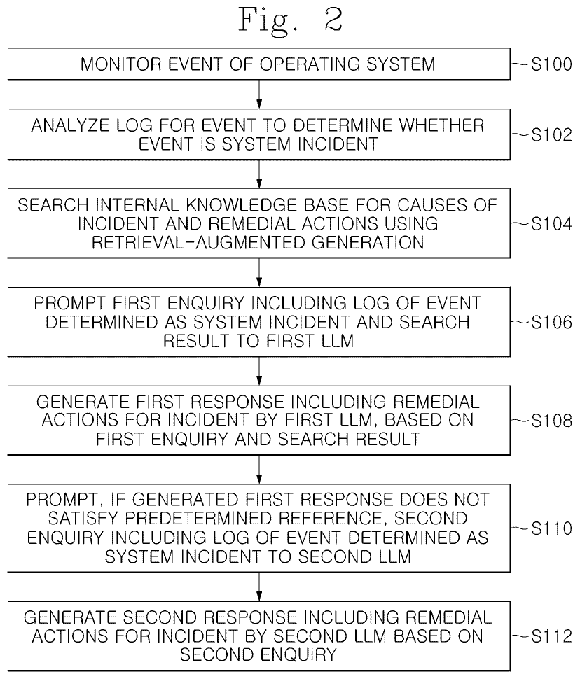

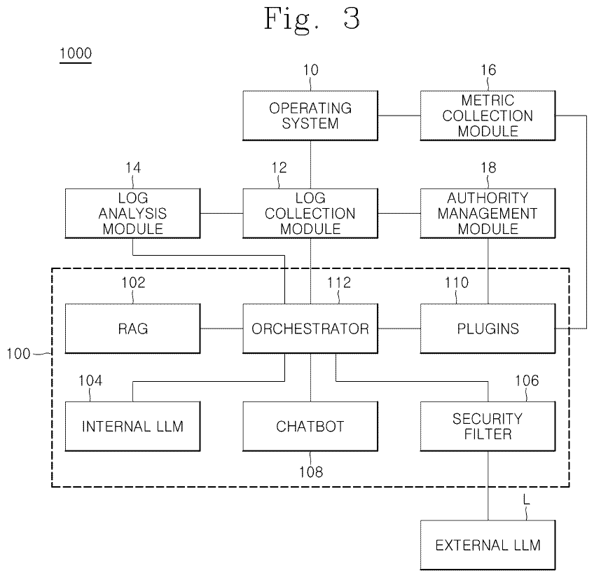

FIG. 2 is a flowchart illustrating an incident response method according to an embodiment of the disclosure, and FIG. 3 is a block diagram specifically illustrating an incident response system according to an embodiment of the disclosure.

An incident response method according to the embodiment of the disclosure includes a step S100 of monitoring an event of an operating system, a step S102 of analyzing a log for the event to determine whether or not the event is a system incident, a step S104 of searching an internal knowledge base for the causes of the incident and remedial actions, based on a retrieval-augmented generation, a step S106 of prompting a first inquiry including a log of the event determined as a system incident and a search result to a first LLM, and a step S108 of generating a first response including remedial actions for the incident by the first LLM, based on the first inquiry and the internal-knowledge base search result. In addition, the method may include a step S110 of prompting, if the generated first response does not satisfy a predetermined reference, a second inquiry including a log of the event determined as a system incident to a second LLM and a step S112 of generating a second response including remedial actions for the incident by the second LLM, based on the second inquiry.

An incident response system 1000 according to the embodiment of the disclosure includes an operating system 10, a log collection module 12, a log analysis module 14, a metric collection module 16, an authority management module 18, and an incident response apparatus 100. Plugins 110 may be connected to the metric collection module 16 and the authority management module 18 to enable generation of the current status of the system through metric analysis, identification of authority of users, and the like. In addition, the plugins 110 may be connected to an API or may execute instructions, thereby performing actions for the incident. An orchestrator 112 is a framework that connects various modules, based on LLMs, to produce a flow.

The operating system 10 may be a system that operates IT services such as a cloud service. Although the log collection module 12, the log analysis module 14, the metric collection module 16, and the authority management module 18 are illustrated as separate modules from the operating system 10 in FIG. 3, the log collection module 12, the log analysis module 14, the metric collection module 16 and the authority management module 18 may be modules inside the operating system 10.

Hereinafter, the incident response method and the incident response system according to the embodiment of the disclosure will be described in detail.

A monitoring module (not shown) of the operating system 10 monitors events, and the log collection module 12 collects logs of the events. The collected logs are analyzed by the log analysis module 14 to determine whether or not an incident such as an error occurs in the operating system 10. If it is determined that an incident has occurred in the operating system 10 as a result of the log analysis, the incident response apparatus 100 may separately perform tasks such as metric collection, knowledge base searching, analysis of causes of the incident, and recommendation of remedial actions.

The incident response apparatus 100 may provide a response message, based on retrieval-augmented generation (RAG). At this time, the incident response apparatus 100 may search for information, based on the internal knowledge base, and generate a response message based on the searched information. In the embodiment of the disclosure, the causes of the incident and remedial actions may be searched for, based on the retrieval-augmented generation, from the internal knowledge base. The retrieval-augmented generation may be executed by a retrieval-augmented generation module 102 and a first LLM 104. The retrieval-augmented generation module 102 may include a knowledge base. In this case, the knowledge base may be an internal knowledge base.

The internal knowledge base may be a vector database, and may be a knowledge base that exists inside a company or a specific organization, or is managed by a company or a specific organization. The internal knowledge base may store internal information such as operating system information, operating system development-related information, operating system incident history, incident report, source code, and manuals for equipment and software used in the operating system, and external information.

The retrieval-augmented generation may be a procedure in which a company or specific organization stores information about the operating system 10 accumulated while operating the operating system 10 in the internal knowledge base and provides an answer to an inquiry by contextualizing and adding search results from the internal knowledge base to a prompt for the LLM.

In addition, if it is determined that an incident has occurred in the operating system 10 as a result of the log analysis, the metric collection module 16 may collect metrics related to the incident. Metrics are indicators for monitoring the status of the system, such as performance, and may include metrics related to the incident, such as response time delay, CPU usage exceeding a reference, memory usage exceeding a reference, I/O increase, and an increase in the number of processes and threads. The current status of the system where the incident occurred may be identified by collecting the metrics.

Afterwards, an inquiry (first inquiry) including a log of the event determined as a system incident and a search result of the internal knowledge base may be prompted (first prompt) to the first LLM 104. The first inquiry may include an inquiry about the causes of the incident and remedial actions. The first LLM 104 may generate a response (first response), based on the first inquiry and the internal-knowledge base search results. In addition, the first LLM 104 may generate the current status of the system where the incident occurred, based on the collected metrics.

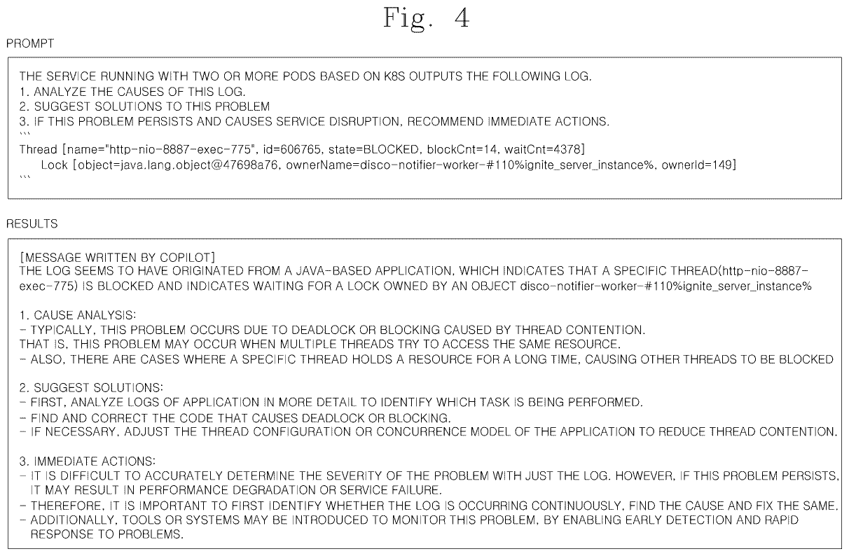

FIG. 4 is a diagram illustrating a first prompt and a first response according to an embodiment of the disclosure.

Referring to FIG. 4, the first prompt includes an inquiry about a log, the causes of an incident, and remedial actions. In this case, the remedial actions may include a solution to the incident and an immediate action (a task that is to be taken immediately). The first response includes the current status of the system where the incident occurred, cause analysis, solution suggestion, and immediate actions in sequence.

The system operator may determine whether or not the response generated by the first LLM 104, i.e., the response regarding the causes of the incident and remedial actions, is appropriate with reference to the response regarding the current status of the system, which is received from the first LLM 104. In addition, in order to determine whether or not the first response satisfies a predetermined reference, the operator may request the first LLM 104 to evaluate the accuracy of the first response. The accuracy evaluation of the first response may be automatically performed by the first LLM 104.

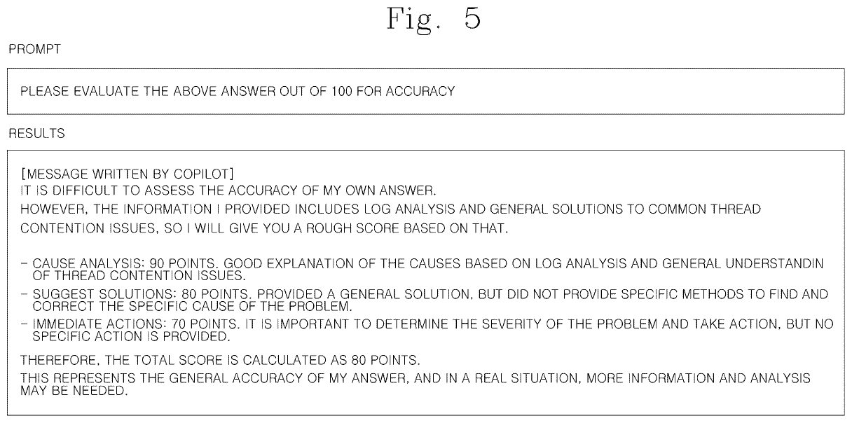

FIG. 5 is a diagram illustrating evaluation of accuracy of a first response generated according to an embodiment of the disclosure. The accuracy may be evaluated based on the explanation of the causes of the incident, solutions to the incident, or whether or not the immediate action is specific. The accuracy may be calculated based on a full score of 100. If the accuracy is, for example, 70 points or more, the first response generated by the first LLM 104 satisfies a predetermined reference, so the first response may be provided to the system operator or user through a chatbot 108.

The first response may include an action button or command capable of executing solution actions along with solutions, and may be output to the system operator. The system operator may transmit the first response including the action button or command to the user, so that it may be output to the user through the chatbot 108. Alternatively, the first response including the action button or command may be output to the user without going through the system operator.

In this case, after identifying whether or not the user has the authority to execute the actions, the first response may be output to the user through the chatbot 108. For example, the action button may be activated only when the user has the authority to execute the actions. The user may select the action button to access an appropriate API for executing the solution actions. The authority management module 18 may identify whether or not the user has the execution authority. In addition, in the case where the execution of the resolution action is important, the action may be executed only with the consent of an operator with execution authority. If there is no operator with authority, a button for requesting temporary authority from the person in charge of the task may be provided through a chatbot 108.

If the first response does not satisfy the predetermined reference, an additional inquiry may be made to the second LLM L. In this case, the second LLM L may be a higher-performance LLM than the first LLM 104. The case where the first response does not satisfy the predetermined reference may be a case where the accuracy of the first response is less than 70 points, a case where there is no information related to the causes of the incident or remedial actions in the internal knowledge base, or a case where the incident is related to open source. If the incident is related to open source, there may be more pieces of information outside the company, so it may be more advantageous to execute search by the second LLM L.

The prompt (second prompt) to be input to the second LLM L may be produced by the first LLM 104 under the instruction of the system operator, or may be automatically produced by the first LLM 104 without the instruction of the system operator. The second prompt may be an inquiry (second inquiry) that includes a log of an event determined as a system incident. In addition, the second inquiry may include an inquiry about the causes of the incident and remedial actions. In this case, the content of the second inquiry may include internal security information that should be restricted from being leaked to the outside, such as a company name providing the relevant IT service, an internal IP, an internal system name, an internal program name, and the like. In this case, the action may be taken to prevent internal information or internal security information from being leaked to the second LLM L.

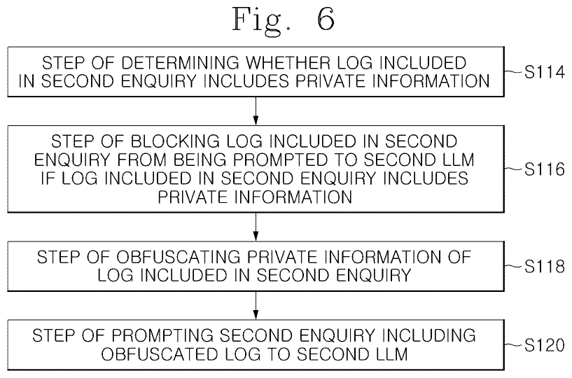

FIG. 6 is a flowchart illustrating specific steps in which a second prompt is input to a second LLM according to an embodiment of the disclosure.

The step S110 of prompting the second inquiry to the second LLM in FIG. 5 may include a step S114 of determining whether or not the log included in the second inquiry includes private information, a step S116 of blocking the log included in the second inquiry from being prompted to the second LLM if the log included in the second inquiry includes private information, a step S118 of obfuscating the private information of the log included in the second inquiry, and a step S120 of prompting the second inquiry including the obfuscated log to the second LLM.

Specifically, actions to prevent internal information or internal security information other than open source from being leaked to the second LLM L may be, for example, determining whether or not private information such as internal information is included in the second inquiry or the inquiry about the log, the causes of the incident, and remedial actions included the second prompt and, if the second inquiry includes internal information, blocking the second prompt from being prompted to the second LLM L by the security filter 106.

Thereafter, the first LLM 104 may obfuscate the private information included in the second inquiry or the second prompt. For example, the code of the log may include a class, a field, and a method, and the names of the class, field, and method may be changed to the corresponding names of the obfuscated class, field, and method.

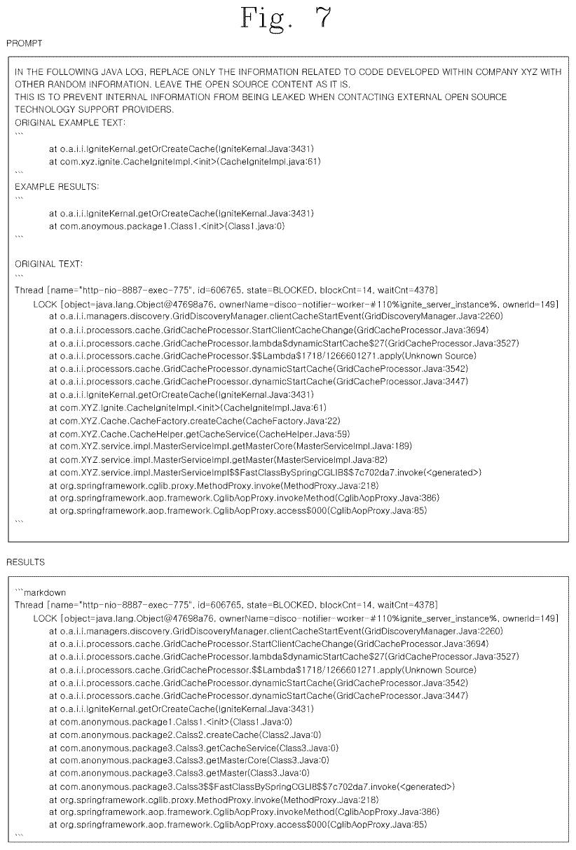

FIG. 7 is a diagram illustrating an obfuscated prompt and an obfuscated log according to an embodiment of the disclosure. Referring to FIG. 7, it can be seen that the class name including the company name XYZ was converted to an arbitrary class name that is not internal information. As described above, by inputting the second prompt including the obfuscated log into the second LLM, internal information may be prevented from being leaked to the outside.

As described above, when the second LLM generates a response (second response) to the second inquiry, it may identify whether or not the user has the authority to execute the action and then output the second response to the user through the chatbot 108. The identification of action authority for the second response is the same as the identification of action authority for the first response, so the description thereof will be omitted.

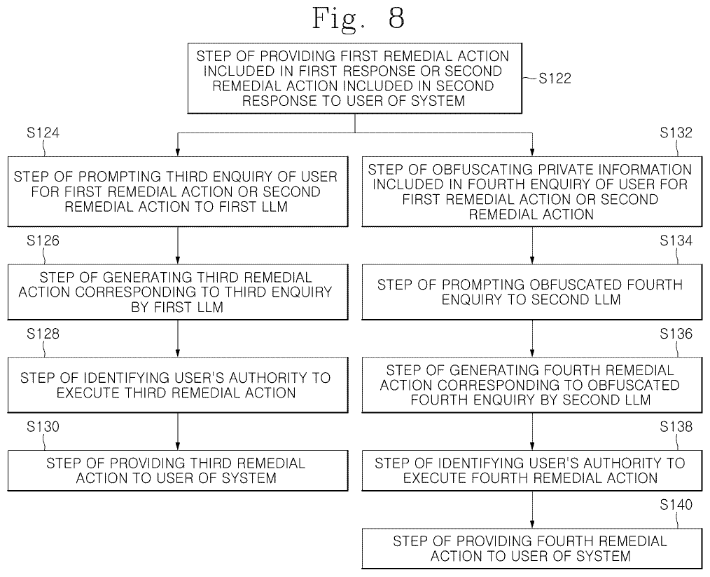

FIG. 8 is a flowchart illustrating specific steps in which a user executes remedial actions according to an embodiment of the disclosure.

A first remedial action included in the first response or a second remedial action included in the second response are output to the user through the chatbot 104. The output message may include an action button, a recommended command, or a button for additional inquiry. The user may select an action button to call and access an appropriate API to execute the remedial action. Alternatively, the user may input a command to execute it.

In addition, the user may make an additional inquiry about the first response or the second response. The user's additional inquiry may be prompted to the first LLM 104 as described above, or may be prompted to the second LLM L. For example, if there is no information related to the causes of the incident or remedial actions in the internal knowledge base, or if the incident is related to open source, the inquiry may be prompted to the second LLM L.

If the user prompts an additional inquiry (third inquiry) to the first LLM 104 for the first response (or first remedial action) or the second response (or second remedial action), the first LLM 104 may generate the cause of the incident and/or a remedial action (third remedial action) as a response to the third inquiry.

If the user prompts an additional inquiry (fourth inquiry) to the second LLM L for the first response (or first remedial action) or the second response (or second remedial action), the second LLM L may generate the cause of the incident and/or a remedial action (fourth remedial action) as a response to the fourth inquiry. At this time, the content of the fourth inquiry may include internal security information that should be restricted from being leaked to the outside, such as a company name providing the relevant IT service, an internal IP, an internal system name, an internal program name, and the like. In this case, the action may be taken to prevent internal information or internal security information from being leaked to the second LLM L.

The action to prevent internal information or internal security information from being leaked to the second LLM L may be an action to block the fourth prompt from being prompted to the second LLM L by the security filter 106 and an action to obfuscate private information included in the fourth prompt. Since these actions have already been described in FIG. 6 above, the description of FIG. 6 may be applied thereto.

After identifying whether or not the user has the execution authority for the third remedial action or the fourth remedial action generated as described above, the third remedial action or the fourth remedial action may be output to the user through the chatbot 108. Since the description of the third and fourth remedial actions are the same as the description of the first and second remedial actions above, the description of the third and fourth remedial actions will be omitted.

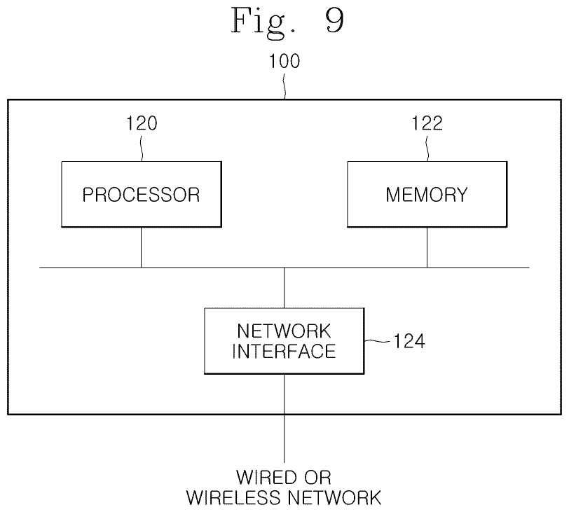

FIG. 9 is a block diagram schematically illustrating the configuration of an incident response apparatus according to an embodiment of the disclosure.

A system incident response apparatus 100 according to an embodiment of the disclosure may be a computing device configured to implement an incident response method according to an embodiment of the disclosure. The incident response apparatus 100 may include a processor 120 and a memory 122. The memory 122 may include instructions configured to be executed by the processor 120, thereby causing the incident response apparatus 100 to perform specific operations. The operations performed by the processor 120 may include: monitoring an event of a system; analyzing a log for the event to determine whether or not the event is a system incident; searching an internal knowledge base for the causes of the incident and remedial actions, based on a retrieval-augmented generation; prompting a first inquiry including a log of the event determined as a system incident to a first LLM; and generating a first response including remedial actions for the incident by the first LLM, based on the first inquiry and search result. In addition, the operations may include: prompting, if the generated first response does not satisfy a predetermined reference, a second inquiry including a log of the event determined as a system incident to a second LLM; and generating a second response including remedial actions for the incident by the second LLM, based on the second inquiry.

The incident response method implemented by the incident response apparatus 100 has been described above, so redundant description thereof will be omitted.

The memory 122 may be connected to the processor 120 during operation, and may store programs and/or instructions for processing and controlling the processor 120, and may store data and information used in the disclosure, control information required for processing data and information according to the disclosure, and temporary data generated during the data and information processing process. The memory 122 may be implemented as a storage device such as a ROM (Read-Only Memory), a RAM (Random Access Memory), an EPROM (Erasable Programmable Read-Only Memory), an EEPROM (Electrically Erasable Programmable Read-Only Memory), a flash memory, a SRAM (Static RAM), an HDD (Hard Disk Drive), an SSD (Solid State Drive), and the like.

The processor 120 may be operatively connected to the memory 122 and/or the network interface 124, and may control the operation of respective modules in the apparatus 100. In particular, the processor 120 may perform various control functions for performing the method according to the embodiment of the disclosure. The processor 120 may also be called a controller, a micro-controller, micro-processor, a micro-computer, or the like. The method according to the embodiment of the disclosure may be implemented by hardware, firmware, software, or a combination thereof. When implementing the disclosure using hardware, an ASIC (application specific integrated circuit) or a DSP (digital signal processor), a DSPD (digital signal processing device), a PLD (programmable logic device), an FPGA (field programmable gate array), or the like, configured to perform the disclosure, may be provided in the processor 120. Meanwhile, when implementing the method according to the embodiment of the disclosure using firmware or software, the firmware or software may include instructions related to modules, procedures, or functions that perform functions or operations necessary for implementing the method according to the embodiment of the disclosure. The instructions may be stored in the memory 122 or stored in a computer-readable recording medium (not shown) separate from the memory 122, and may be configured to cause, when executed by the processor 120, the apparatus 100 to perform the method according to the embodiment of the disclosure.

In addition, the apparatus 100 may include a network interface device 124. The network interface device 124 may be connected to the processor 120 during operation, and the processor 120 may control the network interface device 124 to transmit or receive wireless/wired signals carrying information, data, signals, and/or messages through a wireless/wired network. The network interface device 124 may support various communication standards such as IEEE 802 series, 3GPP LTE(-A), 3GPP 5G, etc., and may transmit and receive control information and/or data signals according to the corresponding communication standards. The network interface device 124 may be implemented outside the apparatus 50 as needed.

The electronic devices, processors, memories, operating systems, neural networks, incident response system 1000, incident response apparatus 100, operating system 10, External LLM L, log collection module 12, log analysis module 14, metric collection module 16, authority management module 18, processor 120, memory 122, and network interface 124 described herein and disclosed herein described with respect to FIGS. 1-9 are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-9 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method, the method comprising:
monitoring an event in a system;
analyzing a log of the event to determine whether the event is a system incident;
searching, responsive to the event being determined to be a system incident event, an internal knowledge base for causes of the system incident event and remedial actions for the system incident event, based on retrieval-augmented generation;
prompting a first inquiry, the first inquiry including the log and a search result from the searching to a first LLM; and
generating a first response comprising remedial actions for the system incident event by the first LLM, based on the first inquiry and the search result.

2. The method of claim 1, further comprising:
prompting, in a first case that the generated first response does not satisfy a predetermined reference, a second inquiry, the second inquiry including the log to a second LLM; and
generating a second response comprising remedial actions for the system incident event by the second LLM, based on the second inquiry.

3. The method of claim 2, wherein the prompting the second inquiry to the second LLM comprises:
determining whether the log comprises private information;
blocking the log from being prompted to the second LLM responsive to the log comprising the private information;
obfuscating the private information of the log to generate an obfuscated log; and
prompting the second inquiry including the obfuscated log to the second LLM.

4. The method of claim 1, further comprising:
collecting metrics of the system related to the system incident event between the analyzing the log and the prompting the first inquiry,
wherein the first LLM is configured to further generate status of the system related to the system incident event, based on the metrics.

5. The method of claim 3, wherein, in the first case that the generated first response does not satisfy the predetermined reference, the method comprises:
generating the second response according to the system incident event including one of a second case where accuracy of the first response evaluated by the first LLM is less than a predetermined score, a third case where there is no information related to the causes of the system incident event or the remedial actions in the internal knowledge base, and a fourth case where the system incident event is related to open source.

6. The method of claim 3, further comprising:
identifying whether a user of the system has an authority to execute a first remedial action included in the first response and a second remedial action included in the second response;
providing the first response to the user responsive to the first response satisfying the predetermined reference; and
providing the second response to the user responsive to the first response not satisfying the predetermined reference,
wherein the second response is generated by prompting the second inquiry comprising the obfuscated log to the second LLM.

7. The method of claim 3, further comprising:
providing a first remedial action included in the first response or a second remedial action included in the second response to a user of the system;
prompting a third inquiry of the user for the first remedial action or the second remedial action to the first LLM; and
generating a third remedial action corresponding to the third inquiry by the first LLM.

8. The method of claim 7, further comprising:
identifying a user's authority to execute the third remedial action; and
providing the third remedial action to the user.

9. The method of claim 3, further comprising:
providing a first remedial action included in the first response or a second remedial action included in the second response to a user of the system;
obfuscating private information included in a fourth inquiry of the user for the first remedial action or the second remedial action;
prompting the fourth inquiry to the second LLM; and
generating a fourth remedial action corresponding to the fourth inquiry by the second LLM.

10. An apparatus, the apparatus comprising:
a processor configured to execute instructions; and
a memory storing the instructions, wherein execution of the instructions configures the processor to:
monitor an event in a system;
analyze a log of the event to determine whether the event is a system incident;
search, responsive to the event being determined to be a system incident event, an internal knowledge base for causes of the system incident event and remedial actions for the system incident event, based on retrieval-augmented generation;
prompt a first inquiry, the first inquiry including the log and a search result from the searching to a first LLM; and
generate a first response comprising remedial actions for the system incident event by the first LLM, based on the first inquiry and the search result.

11. The apparatus of claim 10, wherein the processor is further configured to:
prompt, in a first case that the generated first response does not satisfy a predetermined reference, a second inquiry, the second inquiry including the log to a second LLM; and
generate a second response comprising remedial actions for the system incident event by the second LLM, based on the second inquiry.

12. The apparatus of claim 11, wherein the prompting of the second inquiry comprises:
determining whether the log comprises private information;
blocking the log from being prompted to the second LLM responsive to the log comprising the private information;
obfuscating the private information of the log to generate an obfuscated log; and
prompting the second inquiry including the obfuscated log to the second LLM.

13. The apparatus of claim 10, wherein the processor is further configured to:
collect metrics of the system related to the system incident event between the analyzing the log and the prompting the first inquiry, and
wherein the first LLM is configured to further generate status of the system related to the system incident event, based on the metrics.

14. The apparatus of claim 12, wherein, in the first case that the generated first response does not satisfy the predetermined reference, the generating the second response further comprises:
generating the second response according to the system incident event including one of a second case where accuracy of the first response evaluated by the first LLM is less than a predetermined score, a third case where there is no information related to the causes of the system incident event or the remedial actions in the internal knowledge base, and a fourth case where the system incident event is related to open source.

15. The apparatus of claim 12, wherein the processor is further configured to:
identify whether a user of the system has an authority to execute a first remedial action included in the first response and a second remedial action included in the second response;
provide the first response to the user responsive to the first response satisfying the predetermined reference; and
provide the second response to the user responsive to the first response not satisfying the predetermined reference,
wherein the second response is generated by prompting the second inquiry comprising the obfuscated log to the second LLM.

16. The apparatus of claim 12, wherein the processor is further configured to:
provide a first remedial action included in the first response or a second remedial action included in the second response to a user of the system;
prompt a third inquiry of the user for the first remedial action or the second remedial action to the first LLM; and
generate a third remedial action corresponding to the third inquiry by the first LLM.

17. The apparatus of claim 16, wherein the processor is further configured to:
provide a first remedial action included in the first response or a second remedial action included in the second response to a user of the system;
obfuscate private information included in a fourth inquiry of the user for the first remedial action or the second remedial action as an obfuscated fourth inquiry;
prompt the obfuscated fourth inquiry to the second LLM; and
generate a fourth remedial action corresponding to the obfuscated fourth inquiry by the second LLM.

18. The apparatus of claim 17, wherein the processor is further configured to:
identify a user's authority to execute the third remedial action or the fourth remedial action; and
provide one of the third remedial action and the fourth remedial action to the user.

19. A computer-readable storage medium storing instructions configured to, when executed by a processor, cause a computing apparatus comprising the processor to implement operations, wherein the operations comprise:
monitoring an event in a system;
analyzing a log of the event to determine whether the event is a system incident;
searching, responsive to the event being determined to be a system incident event, an internal knowledge base for causes of the system incident event and remedial actions, based on retrieval-augmented generation;
prompting a first inquiry, the first inquiring including the log and a search result from the searching to a first LLM; and
generating a first response comprising remedial actions for the system incident event by the first LLM, based on the first inquiry and the search result.

20. The computer-readable storage medium of claim 19, wherein the operations further comprise:
prompting, in a first case that the generated first response does not satisfy a predetermined reference, a second inquiry, the second inquiry including the log, causes of the incident and remedial actions to a second LLM; and
generating a second response to the second inquiry by the second LLM, and
wherein the prompting the second inquiry to the second LLM comprises:
determining whether the log included in the second inquiry comprises private information;
blocking the log from being prompted to the second LLM responsive to the log comprising private information;
obfuscating the private information of the log to generate an obfuscated log; and
prompting the second inquiry including the obfuscated log to the second LLM.
